(19) United States
(12) Patent Application Publication
(10) Pub. No.: US 2024/0092008 A1
(43) Pub. Date: Mar. 21, 2024

(54) METHOD AND PRODUCTION SYSTEM FOR THE SIMPLE SEPARATION OF SCRAP ARISING IN THE MANUFACTURE OF EXTRUDED PLATES

(71) Applicant: AKZENTA PANEELE + PROFILE GMBH, Kaisersesch (DE)

(72) Inventors: Felix HÜLLENKREMER, Koblenz (DE); Peter WENDLING, Mörsdorf (DE)

(21) Appl. No.: 18/274,500

(22) PCT Filed: Nov. 12, 2021
(86) PCT No.: PCT/EP2021/081487

§ 371 Date: Jul. 27, 2023

(30) Foreign Application Priority Data
Mar. 17, 2021 (EP) 21163093.4

(51) Int. Cl. B29C 48/275; B29C 48/07; B29C 48/92

(52) U.S. Cl. CPC B29C 48/277; B29C 48/07; B29C 48/92; B29C 2948/92209; B29C 2948/92428; B29C 2948/9279; B29K 2105/26

(57) ABSTRACT

The disclosure provides a method for separating scrap produced during the manufacture of extruded sheets, wherein an extrudate of an extruder is fed to a calender comprising a plurality of temperature-controlled calender rollers, an actual temperature of at least one calender roll is measured, the actual temperature is compared with a nominal temperature provided for this calender roller, and in the case that a difference between the actual temperature and the nominal temperature lies outside a predefined tolerance amount, a part of an in particular endless semi-finished product exiting the calender is discharged as scrap. By treating that part of the semi-finished product which has been exposed to the wrong temperature as scrap, it is particularly easy to identify sheets that do not meet the desired quality requirements essentially without additional measuring effort, so that it is possible to easily discharge scrap produced during the manufacture of extruded sheets.

### CROSS-REFERENCE TO RELATED APPLICATIONS

This application is a U.S. National Phase Application under 35 U.S.C. 371 of International Application No. PCT/EP2021/081487, filed on Nov. 12, 2021, which claims the benefit of European Patent Application No. 21163093.4, filed on Mar. 17, 2021. The entire disclosure of the aforementioned European Patent Application is incorporated herein by reference.

### FIELD

The disclosure relates to a method and a production plant, by means of which scrap produced during the manufacture of extruded sheets can be easily separated. In particular, the extruded sheets can be used to produce panels for covering a surface of a room.

### BACKGROUND

This section provides background information related to the present disclosure which is not necessarily prior art.

From WO 2007/079845 A1 a production plant for panels made of wood is known, in which the desired panel length can be separated from a longer semi-finished product by means of a cutting tool.

From EP 3 578 384 A1 a production plant for panels made of plastic is known, in which first a plate-shaped endless profile is produced.

There is a constant need to be able to easily separate scrap produced during the manufacture of extruded sheets.

### SUMMARY

This section provides a general summary of the disclosure, and is not a comprehensive disclosure of its full scope or all of its features.

It is the object of the disclosure to provide means that enable easy separation of scrap produced during the manufacture of extruded sheets.

One aspect of the disclosure relates to a method for separating scrap produced in the manufacture of extruded sheets, in particular panels for covering a surface of a room, in which an extrudate of an extruder is fed to a calender comprising a plurality of temperature-controlled calender rollers, an actual temperature of at least one calender roller is measured, the actual temperature is compared with a nominal temperature provided for this calender roller, and in the case that a difference between the actual temperature and the nominal temperature is outside a predefined tolerance amount, a part of an in particular endless semi-finished product exiting the calender is discharged as scrap.

The extrudate coming from the extruder, which is designed in particular as a wide-slit extruder, is usually still comparatively warm and soft. With the aid of the temperature-controlled calender rollers of the calender, the extrudate can be solidified by cooling and rolled into a shape desired for a semi-finished product. For example, the calender may have at least four, at least six, at least eight or even more calender rollers to suitably shape and/or cool the extrudate. The semi-finished product exiting the calender is designed in particular as a plate-shaped endless profile. In addition, the semi-finished product exiting the calender may already have a sufficient strength for a conveying device to be able to convey the semi-finished product away from the extruder and from the calender.

In a continuous operating state of a production plant intended for manufacturing the extruded sheets, the semi-finished product can exit the calender essentially as a flat sheet, which may still be subsequently smoothened and separated. However, in a not yet continuous operation of the production plant, in particular in a start-up operation or in the event of an operational malfunction, it may happen, that the semi-finished product exiting the calender is not flat but wavy in shape. In principle, in case of a sufficiently low waviness of the semi-finished product it may be possible to convert the semi-finished product from a wavy shape to a flat shape during subsequent smoothing. However, it has been recognized that this leads to local compressions and strains of the material of the semi-finished product, which result in non-uniform material properties of the separated sheets, thus affecting the quality of the separated sheets. In particular, the non-uniform material properties may impair the visual appearance in a finishing step, for example in that embossed structures are formed to different extents and/or color pigments can adhere to different extents. In order to achieve the best possible quality for the separated sheets, the wavy parts of the semi-finished product are to be discharged as scrap and not be used as a saleable or finishable product. However, after smoothing, it is difficult to identify the previously wavy parts of the semi-finished product by non-destructive methods. Prior to smoothing, the semi-finished product is still comparatively soft, so that contact-based measuring methods for detecting the waviness can damage the shape of the semi-finished product, so that essentially only contactless optical methods could be used to detect the waviness, but these are complex, difficult to perform and expensive.

However, it has been recognized that direct detection of the waviness of the semi-finished product exiting the calender is actually not necessary at all. In particular, quantification of the waviness is not necessary, even if low waviness is considered unacceptable, so that indirect qualitative detection of the waviness is completely sufficient. Here, the knowledge is exploited that the waviness of the semi-finished product can be traced back to the actual temperature of the calender rolls deviating from a certain nominal temperature. If the temperature profile provided by different nominal temperatures of the calender rolls is not realized accurately enough within the calender, for example, different unplanned slip/stick effects can result, in which the material of the extrudate adheres to the respective calender roll for a shorter or longer time and creates a wavy shape for the semi-finished product. In addition, the actual temperature of the temperature-controlled calender roller is usually measured and compared with a nominal temperature in order to be able to control a cooling and/or heating device assigned to the calender roller, with the aid of which the temperature of the temperature-controlled calender roller is controlled. Since the position of the calender roller, the actual temperature of which deviates too much from the nominal temperature, as well as the conveying speed at which the semi-finished product is moved away from the calender roller are known, it is very easy to calculate and identify those parts of the semi-finished product that are actually to be treated as scrap. When, in a later process step, the sheets are separated from the semi-finished product, it is known exactly which separated sheet qualifies as scrap or as product. The scrap can thus be identified almost without additional measurement technology to identify the wavy parts of the semi-finished product and can be separated very easily during regular operation without having to intervene significantly in the production process of the production plant. It is already sufficient to convey the sheets qualifying as scrap to a location different from that of the sheets qualifying as a product. By treating that part of the semi-finished product, which has been exposed to the wrong temperature at a calender roller as scrap, it is possible without additional measuring effort, in a particularly easy way to identify sheets that do not meet the desired quality requirements, so that a simple separation of scrap occurring in the manufacture of extruded sheets is possible.

If the actual temperature deviates from the nominal temperature only within the tolerance amount, the corresponding part of the semi-finished product is not identified as scrap. This allows measurement inaccuracies and rounding errors to be taken into account, so that a certain amount of temporal inertia can be allowed in the temperature control of the respective calender roller. An unstable temperature control for the calender roller can thus be avoided. In addition, manufacturing costs can be kept low without impairing the product quality. Overly sensitive or overly cautious identification of scrap is avoided.

Immediately after extrusion, the extrudate may be at a temperature close to the melting point of the material used for the semi-finished product. Even downstream of the calender, the material of the semi-finished product, which has already cooled somewhat in the calender, may be comparatively soft. In this condition, the semi-finished product can hardly be separated into individual sheets at reasonable costs and with the required precision. For this reason, the semi-finished product can be cooled down downstream of the calender. In this case, cooling can be carried out with the aid of a separate cooling device and/or by natural convection, while the semi-finished product is conveyed away from the calender in the conveying direction with the aid of the conveying device. As a result of the cooling of the semi-finished product, the material of the semi-finished product solidifies and can thus be more easily subjected to a cutting process. It was recognized here that there is an optimum temperature range in which cutting can be carried out particularly cost-effectively and with high quality. In this optimum temperature range, the material of the semi-finished product is still warm enough that, due to its ductility, a mechanical resistance to penetration by a cutting tool is low. Wear of the separating tool can thus be minimized. In addition, brittle fracture with an undefined fracture surface at the cutting point is avoided, so that a particularly smooth cutting surface can be achieved at the cutting point. Here, the ductility of the semi-finished product may be sufficient to create a slight necking at the beginning and the end of the separation point, which avoids a sharp-edged corner between the separation surface and the upper side as well as the lower side of the plate-shaped semi-finished product at the cutting point. Edge breaking at the cutting point is thus avoided. At the same time, the material of the semi-finished product in the optimum temperature range has already cooled down far enough and is hard enough that the material does not stick to the cutting tool or deform too much under the shear stress occurring during the cutting process. The desired shape of the separated sheets can be ensured with a high degree of precision, even with high tolerance requirements, so that a high dimensional accuracy is ensured for the separated sheets. The material can be cut in the optimum temperature range, as in the case of cutting through butter.

A suitable composition of the extruded semi-finished product is given, for example, in EP 3 578 384 A1, the contents of which are hereby referred to as part of the disclosure. A particularly suitable material for the semi-finished product is a thermoplastic, for example polypropylene (PP) as well as homo-, co- or terpolymers of PP, polyethylene (PE), thermoplastic elastomers such as, for example, thermoplastic polyolefins (TPO), thermoplastic styrenes (TPS), thermoplastic polyurethane (TPU), thermoplastic vulcanizates (TPV) or thermoplastic copolyesters (TPC). All of the aforementioned thermoplastics can, in a customary way also comprise fillers, such as chalk, layer silicates or rock flour. For adapting the physicochemical properties of the plastics, it is also possible that the plastics include further additives that modify the corresponding properties of the plastic, such as plasticizers, UV stabilizers, antioxidants, flame retardants, antistatics, impact strength modifiers and/or colorants.

In particular, the conveying device can be composed of different subunits whose respective conveying speeds can be set the same or different. By setting different conveying speeds in different subunits, it is possible in particular to compensate for a reduction in length of the respectively conveyed profile caused by cooling to the extent of a thermally induced shrinkage, so that unnecessary stresses in the conveyed profile caused by thermal expansion effects can be avoided. In particular, the conveying device can be interrupted, for example in the area of a separating device, so that the separating device can perform a continuous separating cut transverse to the conveying direction. In this case, the subunit of the conveying device provided in the conveying direction downstream of the separating device can have a higher conveying speed than a subunit of the conveying device provided in the conveying direction upstream of the separating device, so that the separation of the separated sheets can be improved. The conveying device or the respective subunit of the conveying device can, for example, have actively driven and/or passively co-rotating rollers and/or a belt moving in the conveying direction in order to be able to convey the respective profile in the conveying direction. If the conveying device has only driven rollers as drive means for conveying the semi-finished product, it is possible to provide a distance between the rollers that favors natural convection for cooling the semi-finished product, wherein the distance between successive rollers is small enough to prevent corrugation of the semi-finished product in a partial section that has not yet solidified and is rather soft. The separating device is configured in particular in a straight line up to the separating device, i.e. without curves or bends, so that the semi-finished product can be conveyed without bends along a straight line extending preferably in a horizontal plane.

The separated panels, which qualify as products and not as scrap, can in particular be further processed into panels, by means of which a surface of a room can be covered. For example, the panels can be used as a floor laminate to form a visually appealing floor of the room. The panel can have a panel body based on a cuboid as the basic shape, the longitudinal extension of which is generally greater than its transverse extension, while the thickness of the panel body in the thickness direction is generally smaller than its transverse extension. The panel body may be formed in particular by the separated sheet or a sheet body present after at least one further cutting of the sheet. The panel body can have the on one long side extending in the longitudinal direction a bung shoulder extending in particular continuously in the longitudinal direction and projecting in the transverse direction, and, on the other side, a bung groove formed in the panel body in the transverse direction, so that substantially identically configured panels can be connected to one another abutting at the long sides via a tongue-and-groove joint configured as a bunging. In addition, a locking hook can project in the longitudinal direction from the short side of the panel body which extends in the transverse direction, while a at the other short side of the panel body a tongue body can project, which delimits a receiving groove, so that substantially identically configured panels can also be latched together at their short sides by means of a tongue-and-groove joint. During assembly, the one panel may rest flat on a subsurface defining a plane of use, for example a floor, a side wall or a ceiling of a room. The other panel can, if necessary, positioned for example at an angle of about 30° slightly beveled with respect to an already mounted panel extending laterally next to the panel at the long side and then pivoted onto the subsurface, whereby the tongue-and-groove joint between the locking hook of the panel and the receiving groove of the further panel can be established.

In particular, the semi-finished product exiting the calender is fed to a smoothing unit for smoothing an upper side and/or a lower side of the semi-finished product, in particular with a defined surface quality, wherein the smoothing by the smoothing unit is omitted if the part of the semi-finished product fed to the smoothing unit has previously been subjected to an actual temperature of one of the calender rollers deviating from the nominal temperature by the predefined tolerance amount. Since the temperature measurement in the calender roller can already be used to identify those parts of the semi-finished product that will later be discharged as scrap and not processed further as a product, this information can already be used in the smoothing unit. The semi-finished product conveyed through the smoothing unit is essentially smoothened in the smoothing unit only in those partial areas that have not been identified as scrap in the calender. As a result, it is not necessary to expose parts of the semi-finished product to smoothing with additional energy input, which are later discharged as scrap. In this way, production costs and wear in the smoothing unit can be reduced.

Preferably, the smoothing unit is located almost directly adjacent to the calender. Since it is not necessary to measure the waviness of the semi-finished product between the calender and the smoothing unit, it is possible to install the smoothing unit as close as possible to the calender. The semi-finished product is thus still particularly soft and less strongly cooled and solidified by natural convection, so that the smoothing unit can achieve the desired shape and surface finish of the semi-finished product particularly easily. With a reduced installation space requirement, the smoothing function in the smoothing unit can be improved.

Particularly preferably, after cooling and solidification to form an endless basic profile, the semi-finished product is fed to a separating device for separating individual sheets from the endless basic profile, in particular along a cutting line extending transversely to the conveying direction, wherein sheets which have been separated from a part of the endless basic profile, which has previously been subjected to an actual temperature of one of the calender rolls which deviates by the predefined tolerance amount from the nominal temperature, are discharged as scrap. In the separating device, which is provided anyway, the semi-finished product, which has been solidified into an endless basic profile, is divided into several sheets with a desired geometry. Those separated sheets which are at least partially made from a part of the endless basic profile, are separated and not mixed with the sheets considered to be the product. Scrap can thus be separated particularly easily and efficiently without intervening in the manufacturing process of the production plant. The separated sheets representing scrap have a defined shape which facilitates an automated further processing of the sheets qualifying as scrap. For example, a shredding device for shredding the sheets that have been discharged as scrap can be dimensioned more easily and in a more targeted manner, so that a particularly efficient further processing of the sheets that have been discharged as scrap can take place.

The separating device can separate the sheet from the endless basic profile by means of a cutting tool along the cutting line. The separation of the respective sheet takes place in particular by a chipless separation process, in particular shearing at a knife edge, so that separated chips, which could contaminate and impair the separating device or impair the surfaces of the sheet and/or the endless basic profile can be avoided. Here, the knowledge is exploited that the endless basic profile can still be present in the optimum temperature range even after an intermediate slight cooling and is comparatively soft and ductile, so that a low-wear cutting of the sheet can easily be carried out by a chipless shearing process. In particular, the cutting tool of the separating device is designed to move along with the conveying speed of the endless basic profile in the conveying direction. By moving the cutting tool along in the conveying direction at the same speed as the endless basic profile, a clear-cut cutting edge can be produced, as could otherwise only be produced by cutting an immovable workpiece. A beveled cutting surface of the sheet can thus be avoided, so that the sheet essentially corresponds to a cuboid.

In particular, an identification as scrap in the calender is based exclusively on the measured actual temperature of the at least one calender roller. A further measurement, in particular a contacting or contactless measurement of a waviness of the sheets is just not provided and saved. This means that it is not necessary to install additional measuring equipment in the separating device. The automated sorting out of scrap can be carried out without significant interventions in the individual manufacturing stations of the production plant.

Preferably, the part of the endless basic profile in the separating device that was previously subjected to an actual temperature of one of the calender rollers deviating from the nominal temperature by the predefined tolerance amount is identified based on a conveying speed of the endless basic profile along a conveying direction and a distance between the separating device and the calender along the conveying direction. The conveying speed of the conveying device as well as the distance between the separating device and the calender are known or can be easily determined by measurement. This makes it very easy to determine the time delay with which that part of the semi-finished product for which the calender roller did not have the correct temperature is present as a sheet separated from the solidified endless basic profile. The sheet thus identified as scrap can then be easily removed from the separating device and the sheets considered as product.

Particularly preferably, after cooling and solidification to an endless profile, the semi-finished product is fed to an edge cutting device for cutting off an edge region of the semi-finished product that is lateral to the conveying direction, so that, in the conveying direction downstream of the edge cutting device, the semifinished product is provided as a plate-shaped endless profile with a predefined basic sheet width extending transversely to the conveying direction, wherein the edge regions cut off in the edge cutting device are discharged as scrap. The edge cutting device can basically cut off the edge regions regardless of whether the part of the endless profile currently present in the edge cutting device qualifies as scrap or a product. Preferably, the edge cutting device is not activated to cut off the edge strips when the part of the endless profile fed to the edge cutting device is qualified as a product. As a result, the edge cutting device need not be designed to cut off a wavy body and/or unnecessary wear can be avoided. Since the cut off edge regions and the sheets discharged as scrap are made of the same material, it is easily possible to further process in common both the cut off edge regions and the sheets discharged as scrap, in particular to recycle them. If necessary, the cut off edge regions and the sheets discharged as scrap can be shredded beforehand so that the shredded edge regions and the shredded sheets are of the same shape and do not differ significantly from one another. The further processing, in particular recycling, of the scrap is thus simplified.

The edge cutting device can cut off the edge regions exceeding the desired basic sheet width, in particular continuously. For this purpose, the semi-finished product can run against a stationary knife or a cutting roller, for example. The edge regions are cut off in particular by a chipless cutting process, in particular shearing at a knife edge, so that separated chips which could contaminate and impair the edge cutting device or impair the surfaces of the endless profile are avoided. Here, the knowledge is exploited that the semi-finished product is comparatively soft and ductile in the optimum temperature range, so that a low-wear cutting of the edge regions can easily be carried out by chipless shearing. In addition, it is possible to cut off the cut edge regions as a strip-shaped endless profile, which can subsequently be crushed into pieces of the same size and shape, in particular as granules. This facilitates further processing of the cut off edge regions.

Sufficient installation space can be provided between the edge cutting device and the separating device in order to further process the edge regions cut off in the edge cutting device. For this purpose, the installation space between the edge cutting device and the separating device below the endless profile and the conveying elements provided for conveying the endless profile in the conveying direction may be provided. The further processing of the cut off edge regions can thus follow directly downstream the edge cutting device, without having to significantly enlarge an installation space of the production plant transverse to the conveying direction for this purpose. Instead, the further processing of the cut-off edge regions can be provided in a set-up area that is already used by the conveying device anyway, wherein a height area that is rather less used by the conveying device can be provided for the further processing of the cut-off edge regions. Further processing of the cut-off edge regions can thus be carried out in a manner that is essentially neutral in terms of installation space.

In the conveying direction between the edge cutting device and the separating device, a collection container can preferably be arranged for collecting the edge regions cut off in the edge cutting device. The edge regions cut off as a strip-shaped endless profile can still be connected to the semi-finished product upstream of the cutting tool of the edge cutting device, so that the cut off edge regions can extend in the conveying direction downstream of the cutting tool of the edge cutting device only slightly laterally spaced from the endless profile. The cut off edge regions can thus be easily fed to the collection container provided between the edge cutting device and the separating device while avoiding that the edge regions cut off as an endless profile can break off in an uncontrolled manner. The cut off edge regions can thus easily be continuously discharged and collected in the collection container. The edge regions cut off as a strip-shaped endless profile can break into smaller pieces in the collection container or be crushed in a defined manner beforehand. Preferably, the cut off edge regions are crushed in at least one crushing device, which is in particular configured as a cutting mill, in particular into pourable granules, and are fed as granules to the collection container and/or a recycling container. The collection container can be moved away by a relative movement transversely to the conveying direction and replaced by a still empty collection container, so that the cut off edge regions can be removed batch by batch. Preferably, the cut off edge regions are discharged continuously.

In particular, the collection container can be arranged below the endless profile in the direction of gravity, wherein in particular the endless profile overlaps the collection container as viewed in the direction of gravity at least to a great extent. The collection container can be provided at a sufficiently low level for receiving the cut off edge strips, which may already have been crushed, at least partially offset laterally relative to the endless profile and/or overlapped by the endless profile below the endless profile. Lateral protrusion of the collection container beyond the lateral extension of the endless profile can thus be kept low or even avoided completely. The installation space requirement can thus be minimized. In addition, it is easily possible to configure the collection container open at the top, so that by visual inspection it can easily be determined whether the collection container should be replaced by an empty one. The components of the conveying device provided above the collection container, in particular rollers, and/or the material of the endless profile can cover the upwardly open opening of the collection container and retain broken-off pieces of the cut off edge region jumping up from the interior of the collection container.

In particular, the separated scrap is conveyed, in particular substantially completely, into a recycling container, wherein the recycling container can be connected to the extruder for at least partial and/or temporary loading of an extruder for the production of the semi-finished product with an educt originating from the recycling container. The material composition of the scrap conveyed to the recycling container is nearly identical to the educt fed to the extruder to produce the extrudate. This facilitates an almost complete recycling, where nearly 100% of the scrap can be reused. In particular, the educt for the extruder coming from the recycling container can be mixed with a non-recycled (“virgin”) educt. Preferably, the weight of the contents of the recycling container is measured, for example by placing the recycling container on at least one load cell, so that the educt for the extruder coming from the recycling container can be continuously metered to the extruder with a defined and known mass flow.

Preferably, the separated scrap is crushed in at least one crushing device, in particular designed as a cutting mill, in order to produce pourable granules. In the crushed state, the scrap can be more easily transported and portioned. Since the shredded scrap is melted anyway during recycling into an educt for the extruder, it is not necessary to grind the scrap into particularly small grain sizes, for example sand or dust. Unnecessary energy input in grinding the scrap is thus avoided.

Particularly preferably, the actual temperature of the calender roller is determined at an outer side of the calender roller. The temperature of the outside of the calender roller can be determined directly or indirectly. Instead of determining a core temperature of the calender roller, the determination of the outside temperature of the calender roller can be used to measure the temperature at a measuring point that is particularly relevant for the quality of the semi-finished product. The identification of partial areas of the semi-finished product as scrap or product can thus be carried out with greater accuracy and validity. A falsification of the temperature measurement due to heat conduction effects within the calender roller, in particular during a start-up phase, is thus avoided.

In particular, the actual temperature of the calender roller is determined at several measuring points of the same calender roller, wherein in the case that the difference between the actual temperature and the nominal temperature of the calender roller at at least one measuring point lies outside the predefined tolerance amount, the part of the semi-finished product exiting the calender is discharged as scrap. This allows to measure a temperature distribution within the calender roller. Preferably, it is possible to measure the actual temperature of the calender roller over the entire circumference at several measuring points offset from one another in the circumferential direction and/or in the axial direction, preferably at the outside of the calender roller. The identification of partial areas of the semi-finished product as scrap or product can thus be carried out with a higher accuracy and validity.

Preferably, the actual temperature of several, in particular all, calender rollers of the calender is measured and compared with the associated nominal temperature, wherein in the case that the difference between the actual temperature and the nominal temperature of at least one calender roller lies outside the predefined tolerance amount, the part of the semi-finished product exiting the calender is discharged as scrap. This means that scrap can be identified even if only one of the calender rolls does not have the correct actual temperature. In this way, it can be taken into account that, in particular during a start-up phase the calender rolls reach their nominal temperature at different speeds. The identification of partial areas of the semi-finished product as scrap or product can thus be carried out with greater accuracy and validity.

Particularly preferably the tolerance amount is ΔT 0.5 K≤ΔT≤10.0 K, in particular 1.0 K≤ΔT≤5.0 K and preferably 1.5 K≤ΔT≤2.5 K. With such a tolerance amount of the actual temperature deviating from the nominal temperature, a waviness of the semi-finished product and/or quality losses of the separated sheets due to an uneven density distribution in the semi-finished product are not to be expected. The amount of scrap can thus be kept to the necessary minimum.

In particular, cooling and solidification of the semi-finished product to form a continuous, in particular plate-shaped, profile is effected exclusively by natural convection. An excessively steep temperature gradient in the semi-finished product, which could lead to stresses within the material of the semi-finished product, is thus avoided.

Another aspect of the disclosure relates to a production plant for manufacturing extruded sheets, in particular for panels for covering a surface of a room, comprising an extruder for producing an extrudate, a calender comprising a plurality of temperature-controlled calender rollers for producing a semi-finished product in the form of a plate-shaped endless profile from the extrudate, wherein at least one calender roller comprises a temperature sensor for measuring an actual temperature of the calender roller, a conveying device for conveying the semi-finished product along a conveying direction at a defined conveying speed, and a separating device for separating individual sheets from the semi-finished product solidified into an endless basic profile, in particular along a cutting line extending transversely to the conveying direction, and a discharging device set up for carrying out the method, which can be designed and further developed as described above, for separating those sheets which have been cut from a part of the endless basic profile which has previously been subjected to an actual temperature of one of the calender rollers deviating from the nominal temperature by a predefined tolerance amount as scrap. The production plant can be designed and further developed in particular as described above in terms of the process. By treating the part of the semi-finished product that was exposed to the a calender roll at the wrong temperature as scrap, it is possible, essentially without any additional measuring effort, to identify sheets that do not meet the desired quality requirements, so that it is possible to easily separate scrap produced during the production of extruded sheets.

The discharging device can in particular be part of the separation device. The discharging device can comprise an input port for reading at least one actual temperature of at least one calender roller. The discharging device may comprise a computer unit in which it is checked whether the actual temperature of the calender roller measured at a specific measuring point deviates more than the predefined tolerance amount from the nominal temperature provided for this measuring point. For example, the amount of a difference between the actual temperature and the nominal temperature can be compared with the tolerance amount, wherein in the case that the difference is greater than the tolerance amount, the partial area of the extrudate or semi-finished product that is in contact with this calender roll is identified as scrap and otherwise is identified as no scrap, i.e. product. When a sheet separated in the separating device comprises at least a part of the partial area of the semi-finished product identified as scrap, the discharging device can cause this sheet to be discharged as scrap from the sheets qualifying as product. A part of the conveying means provided downstream of the separating means in the conveying direction may be controlled by the discharging device such that the sheets qualifying as scrap are conveyed to a location different from that of the sheets qualifying as a product.

Preferably, the discharging device is configured to identify from a measurement of the actual temperature of the at least one calender roller and the conveying speed of the conveying device that part of the endless basic profile which was previously exposed to an actual temperature of one of the calender rollers deviating from the nominal temperature by the predefined tolerance amount. For this purpose, for example, the average conveying speed of the semi-finished product between the calender and the separating device can be read in and processed via a further input port. The discharging device can then calculate from the conveying speed where the partial area of the semi-finished product previously identified as scrap in the calender is located, in particular whether the sheet separated in the separating device is made from this part of the semi-finished product identified as scrap. In this way, it is possible to discharge separated sheets as scrap with a high precision for which an insufficient quality can be assumed without further inspection.

Particularly preferred a cutting device is provided downstream of the separating device in the conveying direction, in particular for chipless cutting the sheet that has not been discharged as scrap into individual panels, in particular along at least one cutting line extending in the conveying direction. The cutting of the sheet qualifying as product into panels, or into panel bodies intended for the production of panels, can take place in a temperature range which is still in the optimum temperature range or slightly below. Since the cutting device does not process an endless profile, but already separated sheets, preferably chipless, a good cutting result with flat cutting surfaces can be achieved even at a lower temperature. Instead of continuous cutting, the cutting device can provide batch-type cutting with the use of at least one knife, wherein, due to the lower temperature, it is easily possible to press the panels to be cut by use of at least one hold-down device without fear of wave-like deformation of the sheet and the panels to be cut. The cutting in the cutting device can thus be carried out with a high precision and a good quality of cut.

The separated sheets and/or panels can be stacked towards the end of the conveying device in a packaging device, preferably on a pallet. The stacked sheets and/or panels can, in particular after cooling to ambient temperature, be fed to a further, in particular machining process, for example to form a bung shoulder, a bung groove, a locking hook or a tongue body in the side surfaces connecting the upper side to the lower side.

In particular, the conveying device provides a conveying speed v₁ of 4.5 m/min≤v₁≤21.0 m/min, in particular 5.0 m/min≤v₁≤8.0 m/min and preferably v₁=5.5 m min±0.5 m/min or v₁=7.5 m/min±0.5 m/min. This conveying speed allows a high productivity without inducing unnecessary internal stresses in the semi-finished product.

In addition or alternatively, the conveying speed v₁ is set in such a way that a certain, in particular essentially constant, extruder throughput, for example 6000 kg/h or 8500 kg/h, is achieved for a predetermined thickness and a predetermined basic sheet width of the sheets to be produced. The conveying speed v₁ can thus be adapted to the maximum extruder throughput that can be provided by the extruder, whereby a particularly high productivity is achieved.

Preferably, it is provided that the conveying device applies a compressive force pointing in the conveying direction in particular in an initial region of the semi-finished product facing an extruder, wherein the initial region is in an essentially pasty state, and a tensile force pointing in the conveying direction in particular in an end region of the endless basic profile facing the separating device, wherein the end region is in an essentially solid state, wherein the compressive forces and tensile forces applied are dimensioned in such a way that compression and stretching caused by thermal expansion effects during cooling of the semi-finished product are at least largely compensated for. Here, in particular, the conveying speed along the conveying direction can be adapted locally in such a way that thermal expansion effects due to cooling along the conveying direction and shrinkage of the semi-finished product in the conveying direction can be compensated. The compressive force acting on the soft end of the semi-finished product can in particular be built up by subsequent material of the semi-finished product exiting the calender, while the tensile forces can be provided at the already sufficiently solidified areas of the semi-finished product by an actively engaging conveying element of the conveying system. Unnecessary internal stresses in the semi-finished product can thus be avoided, so that unwanted deformation, for example corrugation, of the semi-finished product can be avoided.

### DRAWINGS

The drawing described herein is for illustrative purposes only of selected embodiment(s) and not all possible implementations, and are not intended to limit the scope of the present disclosure.

In the following, the disclosure will be explained by way of example with reference to the accompanying drawing by way of a preferred exemplary embodiment, wherein the features shown below can each represent an aspect of the disclosure both individually and in combination. In the drawing:

FIG. 1 shows a schematic principle representation of a production plant.

Corresponding reference numerals indicate corresponding parts throughout the view of the drawing.

### DETAILED DESCRIPTION

Example embodiment(s) will now be described more fully with reference to the accompanying drawing.

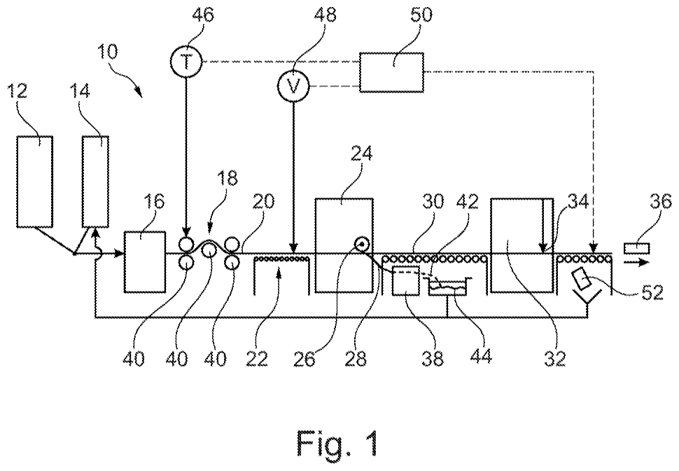

The production plant 10 shown in FIG. 1 comprises a storage container 12 and a recycling container 14, from which at least one extruder 16 or a plurality of extruders 16 may be supplied with an educt to be extruded. The extruder 16 can feed the educt as an extrudate to a calender 18 via a wide slot die, so that downstream of the calender a semi-finished product 20 configured as a plate-shaped endless profile is present, which is discharged in the conveying direction at a specific conveying speed by a conveying device 22, in particular with the use of a pull-off device (not shown). Here, the semi-finished product 20 can be cooled during the conveying, in particular by natural convection, wherein the local conveying speed of the conveying device 22 can be adapted in such a way that thermal expansion effects can be compensated by a shrinkage of the material of the semi-finished product 20. If necessary, the semi-finished product 20 can be fed from the conveying device 22 to a smoothing unit for smoothing an upper side and/or a lower side of the semi-finished product 20 with a defined surface quality. Downstream the optionally provided smoothing, the semi-finished product 20 is fed from the conveying device 22 to an edge-cutting device 24, which cuts edge strips 28, in particular by means of a rolling knife 26, so that an endless basic profile 30 with straightened side edges and a defined basic sheet width transverse to the conveying direction remains on the conveying device 22. In particular, downstream of the edge cutting device in the conveying direction, a pull-off device of the conveying device 22 is provided, in particular configured as a roller pull-off, by means of which the endless basic profile 30 can be pulled away from the extruder 16 and the calender 18. The endless basic profile 30 is subsequently fed to a separating device 32 which, in particular with the use of a guillotine knife 34 moving along in the conveying direction, cuts individual plates 36 which can be fed as a product for further processing. The average temperature of the semi-finished product 20 in the edge cutting device 24 and the average temperature of the endless basic profile 30 in the separating device 32 both lie within a comparatively narrow optimum temperature range in which the material of the semi-finished product 20 and of the endless basic profile 30 is still warm enough so that a mechanical resistance to penetration by a cutting tool is low due to the ductility, but is already hard enough so that the material does not stick to the cutting tool or deforms too much under the shear stress occurring during cutting.

The edge regions 28, cut off as strip-shaped endless profile, are fed to an associated crushing device 38, in which the edge regions 28 are shredded into edge pieces 42 of essentially the same size and can be fed to a common collection container 44. The crushing device 38 and the collection container 44 are arranged between the separating device 32 and the edge cutting device 24 at a height level below the height of the endless basic profile 30. From the collection container 44, the edge pieces 42 can be fed to the recycling container 14, for example with the use of a return conveying device, and reused. Additionally or alternatively, the separated and in particular ground edge pieces 42 can be fed to a container different from the recycling container 14 and fed to the extruder 16 as educt, preferably continuously, via a metering device.

The calender 18 comprises a plurality of temperature-controlled calender rollers 40, by means of which the extrudate of the extruder 16 is formed into the semi-finished product 20, which is configured as a plate-shaped endless profile. Here it is possible that a part of the calender rollers 40 of the calender 18 is used essentially only for cooling the extrudate. The actual temperature of the respective calender roller 40, preferably at its outer side, is measured by means of a temperature sensor 46. In addition, a conveying speed of the semi-finished product 20 is measured by means of a speed sensor 48 and/or provided by the conveying device 22. An operator of the production plant 10 can identify from the comparison of the actual temperature with the nominal temperature, which parts of the semi-finished product 20 can be discharged as scrap without further inspection. Preferably, this is done automatically by feeding the measured actual temperature and the conveying speed to a discharging device 50. The discharging device 50 can check whether the measured actual temperature is within a tolerance range of a target temperature of the assigned calender roller 40. If this is not the case, the discharging device 50 can calculate from the conveying speed when that partial area of the semi-finished part 20 that was positioned in the area of the calender roller with the incorrect temperature at the time of the temperature measurement, is cut off. In this case, the discharging device 50 can control the area following the separating device 34 in such a way that the sheet qualifying as scrap 52 is separated from the sheets 36 qualifying as a product. The sheet qualifying as scrap 52 may be crushed, processed, and fed to the recycling container 14 for reuse.

The foregoing description of the embodiment(s) has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method of separating scrap produced during the manufacture of extruded sheets, in particular panels for covering a surface of a room, in which
an extrudate of an extruder is fed to a calender comprising a plurality of temperature-controlled calender rollers;
an actual temperature of at least one calender roller is measured, the actual temperature is compared with a nominal temperature provided for this calender roller; and
in the case that a difference between the actual temperature and the nominal temperature is outside a predefined tolerance amount, a part of a, in particular endless, semi-finished product exiting the calender is discharged as scrap.

2. The method according to claim 1, in which the semi-finished product exiting the calender is passed to a smoothing unit for smoothing an upper side and/or a lower side of the semi-finished product, in particular with a defined surface quality, wherein the smoothing is omitted by the smoothing unit, if the part of the semi-finished product fed to the smoothing unit has previously been exposed to an actual temperature of one of the calender rollers deviating from the nominal temperature by the predefined tolerance amount.

3. The method according to claim 1 in which an identification as scrap in the calender is carried out exclusively on the basis of the measured actual temperature of the at least one calender roller.

4. The method according to claim 1, in which the semi-finished product after cooling and solidification to an endless basic profile is fed to a separating device for separating separated sheets from the endless basic profile, in particular along a cutting line extending transversely to the conveying direction, wherein sheets formed from a part of the endless basic profile which has previously been subjected to an actual temperature deviating from the temperature of one of the calender rolls by the predefined tolerance amount are discharged as scrap.

5. The method according to claim 4, in which the part of the endless basic profile in the separating device, which was previously subjected to an actual temperature of one of the calender rollers deviating by the predefined tolerance amount from the nominal temperature is identified on the basis of a conveying speed of the endless basic profile along a conveying direction and a distance between the separating device and the calender along the conveying direction.

6. The method according to claim 1, in which the semi-finished product, after cooling and solidification to form an endless profile, is fed to an edge cutting device for cutting off an edge region of the semi-finished product which is lateral with respect to the conveying direction, so that, downstream of the edge cutting device in the conveying direction, the semi-finished product is identified as a plate-shaped profile with a predefined base sheet width extending transverse to the conveying direction, wherein the edge regions cut off in the edge cutting device are discharged as scrap.

7. The method according to claim 1, in which the separated scrap is conveyed, in particular substantially completely, into a recycling container, wherein the recycling container can be connected to the extruder for at least partial and/or temporary loading an extruder for producing the semi-finished product with an educt supplied from the recycling container.

8. The method according to claim 1, in which the separated scrap is crushed in at least one crushing device, in particular to form pourable granules.

9. The method according to claim 1, in which the actual temperature of the calender roller is determined at an outer side of the calender roller.

10. The method according to claim 1, in which the actual temperature of the calender roller is determined at several measuring points of the same calender roller, wherein in the case that the difference between the actual temperature and the nominal temperature of the calender roller at at least one measuring point lies outside the predefined tolerance amount, the part of the semi-finished product exiting the calender is discharged as scrap.

11. The method according to claim 1, in which the actual temperature of a plurality of, in particular all, calender rollers of the calender is measured and compared with the associated nominal temperature, wherein, in the case that the difference between the actual temperature and the nominal temperature of at least one calender roller is outside the predefined tolerance amount, the part of the semi-finished product exiting the calender is discharged as scrap.

12. The method according to claim 1, wherein 0.5 K≤ΔT≤10.0 K, in particular 1.0 K≤ΔT≤5.0 K and preferably 1.5 K≤ΔT≤2.5 K is met for the tolerance amount.

13. The method according to claim 1, wherein cooling and solidification of the semi-finished product to form an endless, in particular plate-shaped, basic profile is effected exclusively by natural convection.

14. A production plant for producing extruded sheets, in particular for panels for covering a surface of a room, comprising:
an extruder for producing an extrudate;
a calender comprising a plurality of temperature-controlled calender rollers for producing a semi-finished product in the form of a plate-shaped endless profile from the extrudate, wherein at least one calender roller comprises a temperature sensor for measuring an actual temperature of the calender roller;
a conveying device for conveying the semi-finished product along a conveying direction at a defined conveying speed;
a separating device for cutting separated sheets from the semi-finished product solidified into an endless basic profile, in particular along a cutting line extending transversely to the conveying direction; and
a discharging device configured for carrying out the method according to claim 1 for separating as scrap those sheets which have been separated from a part of the endless basic profile which has previously been subjected to an actual temperature of one of the calender rollers deviating from the nominal temperature by the predefined tolerance amount.

15. The production plant according to claim 14, wherein the discharging device is adapted to identify from a measurement of the actual temperature of the at least one calender roller and the conveying speed of the conveying device that part of the semi-finished product which was previously exposed to an actual temperature of one of the calender rollers deviating from the nominal temperature by the predefined tolerance amount.
